(19) United States
(12) Patent Application Publication
(10) Pub. No.: US 2012/0257962 A1
(43) Pub. Date: Oct. 11, 2012

(54) POSITIVE DISPLACEMENT PUMP

(76) Inventors: Fuad KOLDZIC, Schwaebisch Gmuend (DE); Thomas Wekenmann, Schwaebisch Gmuend (DE)

(21) Appl. No.: 13/467,321

(22) Filed: May 9, 2012

Related U.S. Application Data
(63) Continuation of application No. PCT/EP2010/065678, filed on May 3, 2012.

(30) Foreign Application Priority Data
Nov. 9, 2009 (DE) 10 2009 046 516.2

(51) Int. Cl. F03B 11/02

(52) U.S. Cl. 415/175

(57) ABSTRACT

A positive displacement pump having a variable flow volume comprises a housing having an outer ring inserted in an internal space of the housing, the outer ring supporting a rotor set comprising a rotor, rotor elements and a cam ring. The rotor is surrounded by the cam ring. Working chambers are formed between the rotor and the cam ring, the volumes of the chambers being adjustable by varying the eccentricity between the rotor and the cam ring. Pressure chambers are formed between an outer peripheral surface of the cam ring and the outer ring. A control piston is connected to the pressure chambers by way of associated control bores which extend at least approximately axially in the cover plate radially inside a peripheral flange of the housing and extend through a face plate which is disposed on the inside axially in front of the rotor set into the pressure chambers.

This is a Continuation of PCT/EP2012/065678 filed Oct. 19, 2010.

### BACKGROUND OF THE INVENTION

The invention relates to a positive displacement pump.

DE 10 2006 012 357 A1 discloses a positive displacement pump of the type in question, which is provided for a power steering system of a motor vehicle.

A rotor set is disposed in the interior of a housing comprising a cover plate and a circular peripheral flange that extends in the direction of the longitudinal axis of the pump. In the process, rotor elements are surrounded by a cam ring. The volume of the working chambers between the individual rotor elements can be adjusted by varying the eccentricity between a rotor and the cam ring, the cam ring being correspondingly shifted to accomplish the adjustment.

Provided for the purposes of pressurizing the chambers is a control piston which is connected to each chamber by means of an associated bore. The pressure medium is fed from the control piston to the chambers by means of axial control bores disposed in the flange of the housing. The pressure medium is routed to the working chambers through the flange, via inclined bores in the cover and via axial return bores. The disadvantage of this design is that there exists an external high pressure interface between the cover and the housing, the interface posing the risk of leakage and needing to be well-sealed as a result. For this reason, there are also high manufacturing costs associated with this design. Moreover, the space requirements are also greater as a result.

### SUMMARY OF THE INVENTION

The object of the present invention is to improve upon a positive displacement pump of the type mentioned above in such a way as to eliminate any external high pressure interface and such that the manufacturing costs and space requirements are lower.

The actuation of the cam ring and the delivery of the pressure medium to the working chambers is no longer accomplished by way of a through-bore in the peripheral flange of the housing and introduction by way of the cover; rather, the control bores are moved further into the interior space of the pump, and more specifically to an area inside the peripheral flange. This allows the bores to be designed as short axial bores and to be routed either directly or indirectly to the cam ring and working chambers through a face plate on a very short path.

By doing away with two deep bores, each with two drilled diameters, in the housing and by doing away with two other inclined bores in the cover, manufacturing costs can be reduced. Moreover, there is also no need for grooves to be made in the cover for an O-ring seal.

Another advantage of the solution according to the invention is that, if necessary, two seals for the control bores in the cover can be eliminated by standardizing the chamber seals using only a single shaped sealing ring in the face plate.

The possibility of changing the routing of the control bores, so that the valve piston and thus the pressure/suction connections can be moved further inward toward the center, also contributes to the reduction in required space.

By shifting the valve piston further toward the center of the housing, it is also possible to design the control bores as simply perpendicular or axially parallel bores.

Advantageous embodiments and refinements of the invention will be apparent from the remaining dependent claims and the exemplary embodiment described hereafter based on the drawing.

### BRIEF DESCRIPTION OF THE DRAWINGS

FIG. 1: A cross-section through a positive displacement pump according to the prior art.

FIG. 2: A side view of the positive displacement pump of FIG. 1 according to the prior art.

FIG. 3: A longitudinal section through the positive displacement pump according to the prior art.

FIG. 4: A view according to line IV-IV of FIG. 3 according to the prior art.

FIG. 5: A cross-section through the positive displacement pump according to the invention (section is the same as in FIG. 1).

FIG. 6: A side view of the positive displacement pump according to the invention (section is the same as in FIG. 2).

FIG. 7: A longitudinal section through the positive displacement pump according to the invention (section is the same as in FIG. 3).

FIG. 8: A section according to line Vlll-Vlll of FIG. 7.

FIG. 9: A longitudinal section through the positive displacement pump according to the invention, with a cover.

FIG. 10: A view of the face plate of the positive displacement pump as seen from the direction of the pressure chambers.

FIG. 11: A view of the face plate as seen from the suction side.

### DESCRIPTION OF THE PREFERRED EMBODIMENTS

Positive displacement pumps having variable delivery volumes, in particular vane cell pumps, are known from the general prior art, which is why the following details only pertain to features which are material to the invention. As regards the prior art, reference is made again to DE 10 2006 012 357 A1 mentioned above, and also to DE 199 42 466 A1.

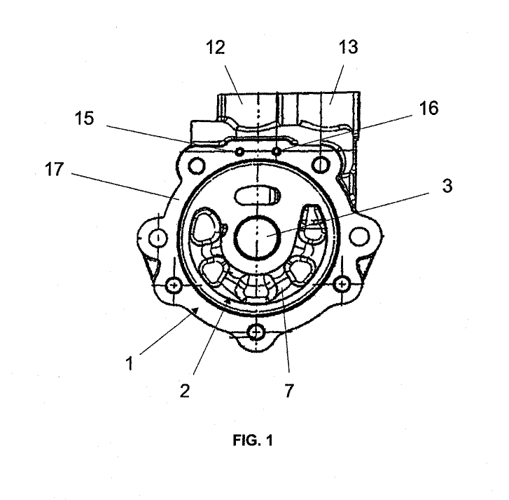

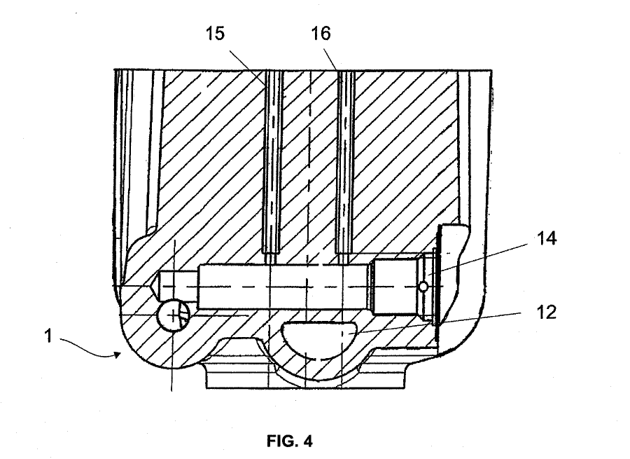

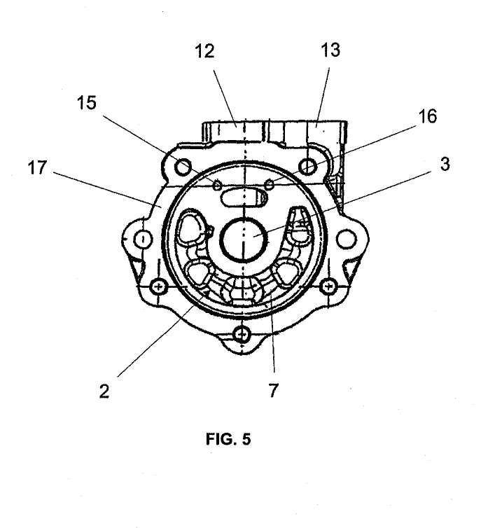

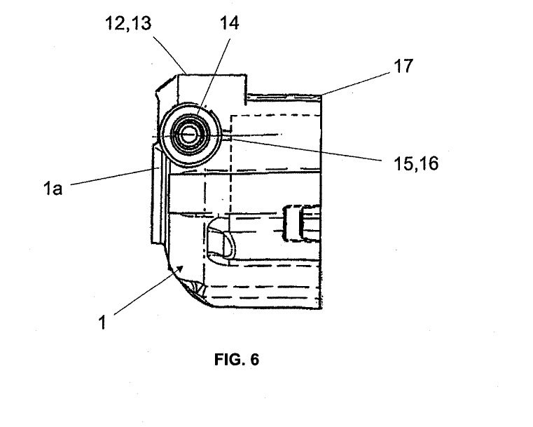

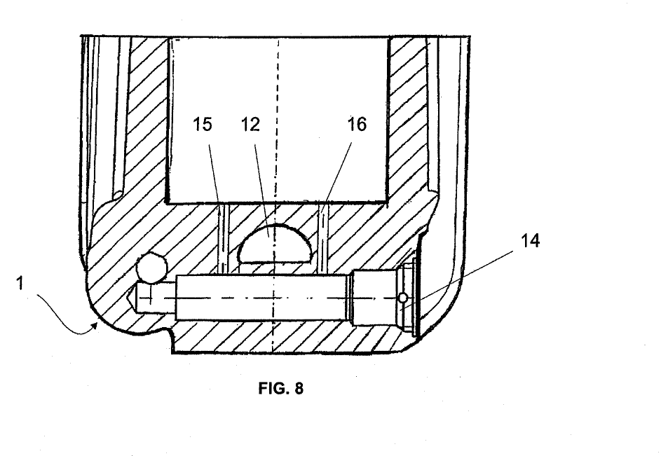

The positive displacement pump shown in the figures is designed as a vane cell pump. FIGS. 1 to 4 show a positive displacement pump according to the prior art. FIGS. 5 to 11 relate to a positive displacement pump according to the invention. The positive displacement pump comprises a housing 1 having a rotor set 2, a rotor 3, rotor elements 4 and a cam ring 5. Also, an outer ring 6 for receiving the rotor set 2 and the rotor elements 4 is inserted in the housing 1.

The outer ring 6 assures the mobility of the cam ring 5 and transfers the transverse forces from the cam ring 5 to the housing 1. However, in principle the housing 1 itself can also assume the function of the outer ring 6.

The rotor 3 is surrounded by the cam ring 5. Working chambers 7, delimited by rotor elements 4, are formed between the rotor 3 and the cam ring 5, the volumes of the chambers being adjustable in a known fashion by varying the eccentricity between the rotor 3 and the cam ring 5. In the exemplary embodiment, the rotor elements 4 are designed as vanes.

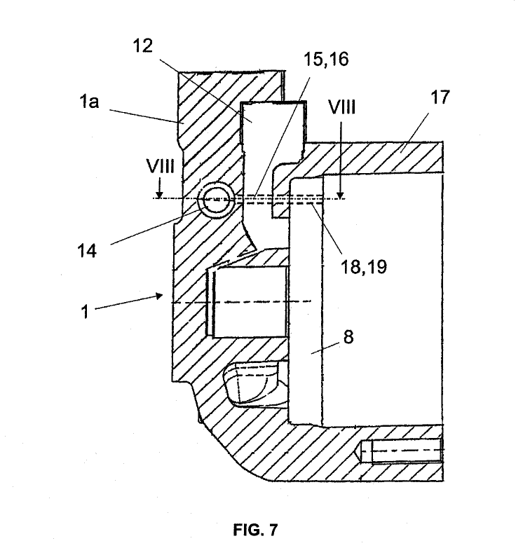

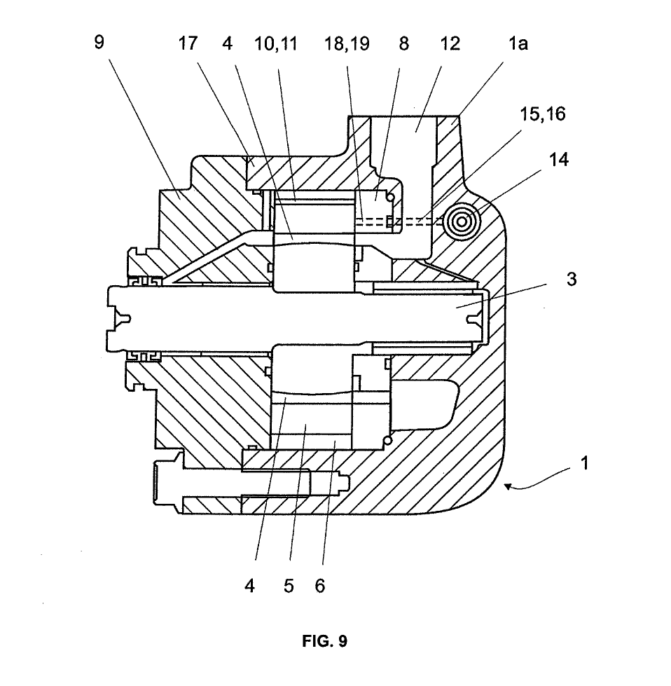

The vane cell pump shown also comprises a face plate or side plate 8 (only shown in FIGS. 7 and 9), which limits the rotor set 2 laterally and which has a pump suction opening and a pump pressure opening in a known fashion, not shown in detail. In the exemplary embodiment, the face plate 8 is placed between an end face of the rotor set 2 and the housing 1. The end face of the rotor set 2 facing away from the face plate 8 is sealed by a housing cover 9 (only shown in FIG. 9).

The housing 1 has an end-face cover plate 1a with an axially running peripheral flange 17 that extends from the outer periphery of the plate. The peripheral flange 17 is sealed by the housing cover 9 on the side facing away from the cover plate 1a.

The positive displacement pump shown also has a first and a second pressure chamber 10, 11 in normal fashion, said chambers being designed on two sides of an outer peripheral surface of the cam ring 5 between the cam ring 5 and the outer ring 6 and being pressurized in order to displace the cam ring 5. The functional principle of applying pressure to the outer peripheral surface of the cam ring 5 is adequately described in the general prior art, for example in DE 199 17 506 B4.

A control piston 14 is connected to each pressure chamber 10, 11 by way of control bores 15 and 16. The pressure chambers 10, 11 can be alternately connected to both the operating pressure of the pump and to a vessel connection by the control piston 14. The cam ring 5 is displaced as a result of the pressure difference that develops in the pressure chambers 10, 11.

The positive displacement pump also has a suction connection 12 and a pressure connection 13.

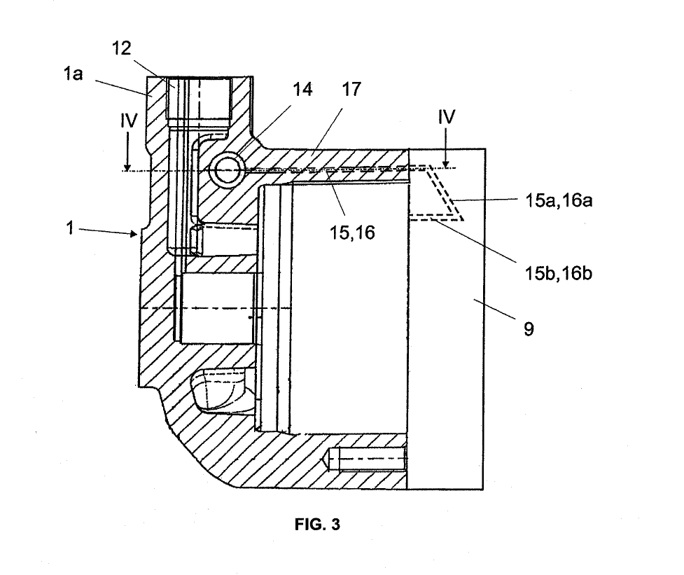

In the design of the positive displacement pump according to FIGS. 1 to 4, both control bores 15 and 16 run from the control piston 14 axially through the peripheral flange 17 of the housing 1 and lead into the housing cover 9. The housing cover 9 is provided with inclined bores 15a and 16a and adjoining channels 15b and 16b which run axially in the direction of the pressure chambers 10 and 11 to supply them with pressure medium, as is indicated in FIG. 3.

In contrast to the prior art, according to the invention, control bores 15 and 16 are no longer disposed in the outer area of the housing 1 or of the cover plate 1a and also no longer run axially through the peripheral flange 17 to the housing cover 9. Rather, both control bores 15 and 16 are disposed radially inside the peripheral flange 17 of the housing 1. Bores 18 and 19 (see FIG. 9) in the face plate 8 align with control bores 15 and 16 and lead axially into the sickle-shaped pressure chambers 10, 11.

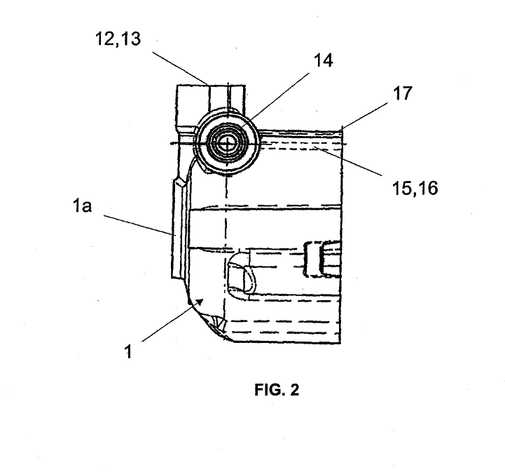

As apparent from FIGS. 5 to 8, the control bores 15 and 16 according to the invention are substantially shorter than control bores 15 and 16 known from the prior art. This becomes clear in particular when comparing FIGS. 2 and 3 to FIGS. 6 and 7 of the embodiment according to the invention. This measure results in a substantial reduction in space requirements, since the control piston 14 and the pressure and suction connections 12 and 13 can be moved further inward in this way. This is also apparent when the figures are compared. Making the routing of control bores 15 and 16 simpler and shorter also results in simplification of manufacturing and cost reductions.

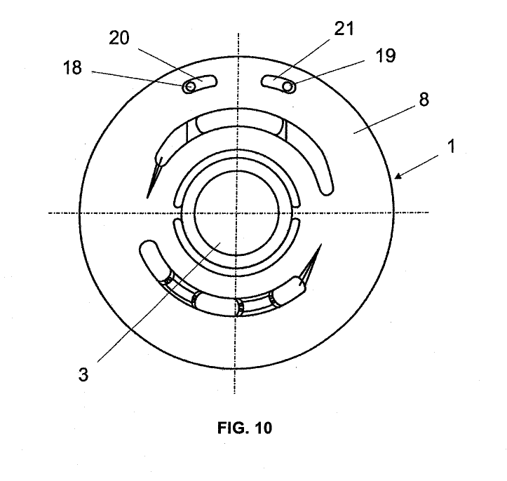

So as to improve the distribution of the pressure medium into the pressure chambers 10, 11, the bores 18 and 19 lead into grooves 20 and 21 on the end face facing the pressure chambers, the grooves extending in the peripheral direction of face plate 8, as is apparent from FIG. 10.

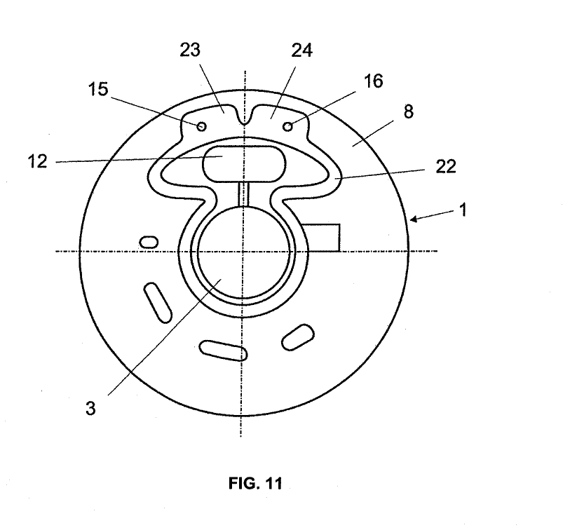

On the end face of the face plate facing the suction side, a shaped sealing ring 22 surrounds the suction connection 12 and the rotor 3, as is apparent from FIG. 11.

Expanded areas of the shaped seal 22, in the form of “eyes” 23 and 24 surround the control bores 15 and 16. This embodiment allows the pressure area of the positive displacement pump to be sealed from the suction area using only one shaped seal 22.

### LIST OF REFERENCE NUMERALS

1 housing
1a cover plate
2 rotor set
3 rotor
4 rotor element
5 cam ring
6 outer ring
7 working chamber
8 face plate or side plate
9 housing cover
10 pressure chamber
11 pressure chamber
12 suction connection
13 pressure connection
14 control piston
15 control bore
15a inclined bore
16 control bore
16a inclined bore
16b channel
16c channel
17 peripheral flange
18 bore
19 bore
20 groove
21 groove
22 shaped seal ring
23 eye
24 eye

1. A positive displacement pump having a variable flow volume comprising a housing having a cover plate and a circular peripheral flange that extends in the longitudinal axial direction of the pump, with an outer ring being inserted in an internal space of the housing, said outer ring supporting a rotor set comprising a rotor, rotor elements and a cam ring, wherein the rotor is surrounded by the cam ring and working chambers, which are delimited by the rotor elements, are formed between the rotor and the cam ring, the volumes of said chambers being adjustable by varying the eccentricity between the rotor and the cam ring, and wherein pressure chambers, which can be pressurized so as to displace the cam ring, are formed between an outer peripheral surface of the cam ring and the outer ring, wherein a control piston is provided for applying pressure, said piston being connected to the pressure chambers by way of associated control bores, further comprising control bores extending axially in the cover plate, the control bores extending radially inside the peripheral flange of the housing, the control bores extending through a face plate, which is disposed on the inside axially in front of the rotor set, into the pressure chambers; and the control piston is displaced further inward toward the center.

2. The positive displacement pump according to claim 1, wherein the control bores lead into grooves or recesses on an end face facing the pressure chambers via bores in the face plate.

3. The positive displacement pump according to claim 2, wherein the grooves extend in the peripheral direction of the face plate.

4. The positive displacement pump according to claim 1, wherein an end face of the face plate on a side facing the cover plate of the housing is provided with at least one seal which surrounds the control bores.

5. The positive displacement pump according to claim 4, wherein the seal is part of a shaped sealing ring that surrounds a suction connection and the rotor.

6. The positive displacement pump according to claim 1, wherein the pump is a vane cell pump.
